(19) United States
(12) Patent Application Publication
(10) Pub. No.: US 2012/0204149 A1
(43) Pub. Date: Aug. 9, 2012

(54) DISCOVERY-BASED MIGRATION CORRECTNESS TESTING

(75) Inventors: Nikolai A. Joukov, Thornwood, NY (US); Birgit M. Pfitzmann, Valhalla, NY (US)

(73) Assignee: INTERNATIONAL BUSINESS MACHINES CORPORATION, Armonk, NY (US)

(21) Appl. No.: 13/020,525

(22) Filed: Feb. 3, 2011

(51) Int. Cl. G06F 9/44

(52) U.S. Cl. 717/121

(57) ABSTRACT

Software components migrated from a source server to a target server may be compared before and after a migration. In one aspect, discovery tools may be used to discover the source server's configurations before the migration. Similarly, discovery tools may be used to discover the target server's configurations after the migration. A migration design or plan may be applied to the discovered source server configurations to generate a desired target server configuration. The desired target server configurations may be compared with the discovered target server configurations. Deviations or differences between the discovered target server configurations and the desired target server configurations may be determined. A database of common or typical changes, which might not be specified in the migration plan, may be used to identify the common changes that occur as part of a migration process, from the deviations.

### FIELD

The present application generally relates to computer systems, and computer system service technologies and information technology (IT) transformation tasks.

### BACKGROUND

Migration, consolidation, virtualization, and cloudification are some of the information technology (IT) transformation tasks, particularly involved with the current era of cost savings and green data centers. In this disclosure, those and the like tasks are collectively referred to as “migration.” A task in migration includes the discovery of dependencies or affinities, i.e., what components (servers, applications, application modules, databases, etc.) depend on what other components, so that the correct components are migrated.

After migration, migrated components on target system should be tested to ensure that the components were migrated correctly and the correct configuration changes were made. Such testing, however, is time consuming and can get expensive. Typically, an entire suite of user acceptance tests (UAT) for the enterprise applications supported by the migrated components is carried out, even though not much should have changed in a migration, because there are not enough specialized cheaper tests for migration. An overview of existing testing methods for migration can be found in Don Estes: Migration Project Testing, 2000 Technologies Corporation, “http://www.2000technologies.com/MigrationTesting.htm”, 2004.

In a migration scenario, many parameters, e.g., component addresses, necessarily change. Therefore, straight comparison of the configuration files between a source system and a target system may not be enough to provide an accurate but fast migration testing.

### BRIEF SUMMARY

Techniques for discovery-based migration correctness testing may be provided. In one aspect, a method for discovery-based migration correctness testing may include discovering source software components, configurations of the source software components of a source system, and one or more dependencies between the source software components. The method may also include discovering target software components, configurations of the target software components of a target system, and one or more dependencies between the target software components. The method may further include comparing using a recorded migration design, the configuration of the source software components of a source system with the configuration of the target software components of a target system, and the one or more dependencies between the source software components with the one or more dependencies between the target software components. The method may yet further include determining whether one or more deviations exist in the configuration of the target software and/or in said one or more dependencies between the target software components, from a desired migrated target as specified in the recorded migration design.

A system for discovery-based migration correctness testing, in one aspect, may include a discovery module operable to discover source software components, configurations of the source software components of a source server, and one or more dependencies between the source software components. The discovery module may be further operable to discover target software components, configuration of the target software components of a target server, and one or more dependencies between the target software components. The system may also include a comparison module operable to compare, using a migration design, the configuration of the source software components of a source server with the configuration of the target software components of a target server, and the one or more dependencies between the source software components with the one or more dependencies between the target software components. The migration design may include a plan of what elements of the source server should remain the same in the target server, and what elements should change in the target server. The comparison module may be yet further operable to determine whether one or more deviations exist in the configuration of the target software and/or in said one or more dependencies between the target software components, from a desired migrated target as specified in the recorded migration design.

Yet in another aspect, a method of discovery-based migration correctness testing may include receiving data discovered associated with source software components to be migrated from a source server to a target server, the data associated with source software components including at least configurations of the source software components of the source server, and one or more dependencies between the source software components. The method may also include receiving data discovered associated with target software components corresponding to the source software components migrated to the target server, the data associated with target software components including at least configurations of the target software components of the target server, and one or more dependencies between the target software components. The method may further include comparing using a migration design, the configuration of the source software components with the configuration of the target software components, and the one or more dependencies between the source software components with the one or more dependencies between the target software components. The method may also include determining whether one or more deviations exist in the configuration of the target software and/or in said one or more dependencies between the target software components, from a desired migrated target as specified in the migration design.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method of discovery-based migration correctness testing in one embodiment of the present disclosure.

FIG. 2 is a block diagram showing system components of the present disclosure in one embodiment.

FIGS. 3A and 3B illustrate an example of a source system and a target system in migration with errors that a test method of the present disclosure in one embodiment may find.

### DETAILED DESCRIPTION

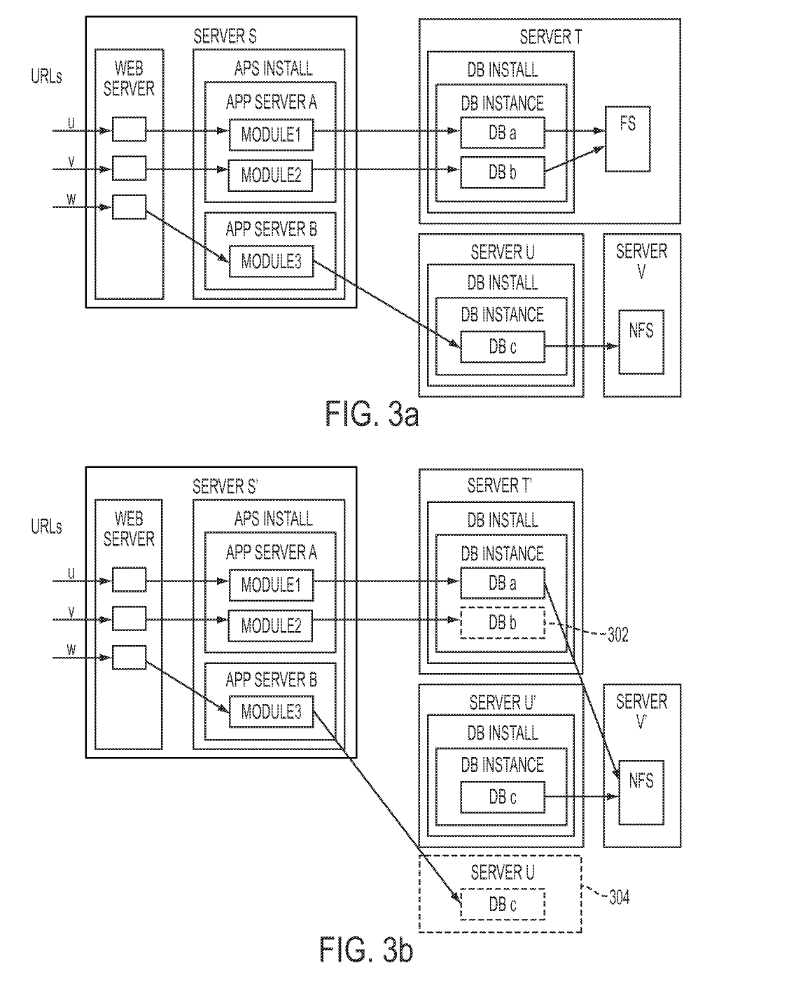

The present disclosure in one aspect provides for an automated migration testing based on comparing discovered server and software configuration before and after migration, taking into account desired changes from a migration design. The automated migration testing of the present disclosure may be utilized alone without employing further testing technique or, for example, for the first line of defense to catch obvious mis-configuration errors before more comprehensive testing. The automated migration testing of the present disclosure also may provide immediate root cause for errors or anomalies that it finds. As a simple example, the testing may find that a certain software sub-component, e.g., a particular database instance or a particular application server node, has not been migrated at all (e.g., in FIG. 3B, this may be Database b as will be explained in more detail below), or that it is not listening on any port while it was doing so before, and thus presumably it has not been started successfully. As the method of the present disclosure in one embodiment finds this directly in the configuration, this is immediately considered as the error root cause. This is a benefit compared with an input/output comparison test or a UAT where it may initially only be noticed that certain transactions no longer work (e.g., in FIG. 3B, this may be a web transaction starting at URL v), but one then has to start debugging which of the components involved in these transactions is causing the problems. More examples are explained below with reference to FIGS. 3A and 3B.

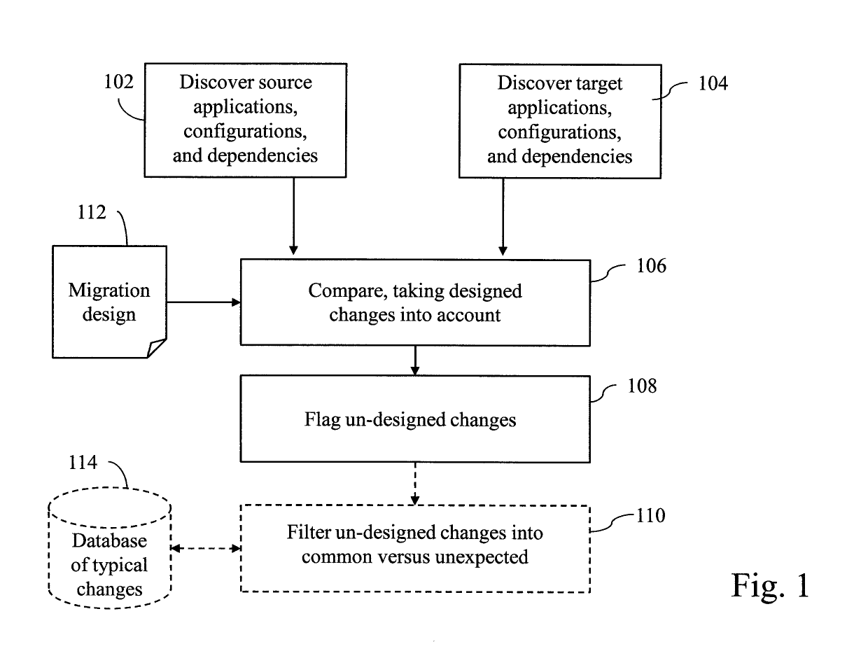

FIG. 1 is a flow diagram illustrating a method of discovery-based migration correctness testing in one embodiment of the present disclosure. At 102, source software components, configurations and dependencies are discovered. That is, the software components that are to be migrated from a source system to a target system may be discovered, their configurations in the source system may be discovered, and dependencies of those software components may be discovered. Discovery could be performed using tools such as IBM Tivoli™ Application Dependency Discovery Manager (TADDM) or Galapagos (from International Business Machines Corporation, Armonk, N.Y.) that execute discovery code on each server and collect configuration and run-time information.

An enterprise application is a set of software components performing a specific function, e.g., a travel reimbursement application, or a web catalogue, and may include several software components, e.g., a web server and a Java™ application using a database to answer specific queries. Configurations may include sets of parameters of software components, e.g., database names, locations, network ports to listen to, other databases to connect to. Dependencies specify information such as whether a software component depends on another component, or if it is configured to use that other component for proper operation. For example, a Java™ application may have a dependency on a database if it is configured to use it.

Dependencies may include other applications or files that depend on the discovered software components as well as those that the discovered software components depend on. For example, software components and data stored in multi-tiered distributed environment, for instance, comprising Web services, application services, databases, enterprise information systems, file systems, storage controllers, and other storage systems, may have dependencies and relationships with one another, and the related software components and stored data may rely on the presence of one or another in order for the supported enterprise applications to run correctly.

Existing techniques that discover dependencies, e.g., in standardized configuration files, codes, or non-standard property files used by the codes may be utilized. For configuration files this may be done, for example, by the IBM™ Tivoli™ Application Dependency Discovery Manager (TADDM) product or by the IBM™ Galapagos tools. For codes and non-standard property files this may be done as described in U.S. patent application Ser. Nos. 12/511,506 and 12/553,486, for example, which applications are incorporated herein by reference. For dependencies that are not represented in one place, but in several pieces, backtracking to all these pieces may be performed.

In another aspect, instead of manipulating configuration files or the like directly, one may also interact with the components that are configured via these files or the like, using management interfaces of these components. Middleware components that are sold to multiple users typically have such management interfaces, e.g., JMX™.

At 104, target applications, configurations and dependencies are discovered. The same methodology used in step 102 may be utilized to discover the target applications, configurations and dependencies. For instance, target application configurations and dependencies may be discovered after the software components are migrated from the source to the target.

In one aspect, both the source and target servers may be up and running. This may be the common case in real-life in particular if the migration involves any changes—since one typically does not switch the source application off before one has tested the target. In other cases, e.g., with a lift-and-shift migration, i.e., putting servers on trucks (or other transportation medium) and transporting them to a new data center, the source system is shut down and reappears as the target system. Still, some test is needed as some software components may not restart, or, e.g., IP addresses may change and some components may use those instead of DNS names. In the latter case we can still use the source configuration captured when the server was running.

Migration design 112 is a plan of what elements of the source system should remain the same in the target system, and what should change in the target. For example, a target design may specify that all components remain, no new components are added, but the server names change (e.g., from S to S′). A migration design with just server name changes might look as follows:

| Source | Target |
|---|---|
| empdbsrv.company.com | empdbsrv2.newplace.company.com |
| jacunix.pok.yyy.com | jaczlinux.pok.yyy.com |
| d02ops004.xxx.yyy.com | d02004zlinux.xxx.yyy.com |
| . . . | . . . |

Or only the server IP addresses change; this might again be represented as a table, or including wildcards, e.g., if entire subnets change, e.g., servers from subnet 10.1.123.* are moved to subnet 11.2.234.* where the last address component remains the same. In the most complex cases, the migration design may include entire data structures describing the source system as after discovery and some abstraction, e.g., an XML structure or database tables and similar data structures describing the desired target system, together with pointers (links, references) between corresponding source and target elements. For instance, representations of Servers S and T as shown in FIG. 3A might look as follows in XML style:

<Server name=“Server-S” id=“N-0”>

<IP addresses=“10.1.123.3 9.9.99.3”/>
<OS name=“AIX” version=“5.3”/>
<Install name=“WebSphere application server” version=“5.3”
id=“N-1”>

<Service name=“AppServer-A” type=“app_server”
ports=“9999 8888” id=“N-2”>

<Object name=“Module1.war” type=“module”
id=“N-3”>

<Dependency
refurl=“db2://Server-T:50000/DB-a”
refid=“N-11”/>

</Object>
<Object name=“Module2.jar” type=“module”
id=“N-4”>

<Dependency
refurl=“db2://Server-T:50000/DB-b”
refid=“N-12”/>

</Object>

</Service>
<Service name=“AppServer-B” type=“app_server”
ports-“7777” id-“N-5”>

<Object name=“Module3.war” type=“module”
id=“N-6”>
<Dependency refurl=“db2://Server-U:50050/DB-c”
refid=“N-20”/>

</Object>

</Service>

</Install>
<Install name=“Apache HTTP Server” version=“2.0.52” id=“N-7”>
...
</Install>

</Server>
<Server name=“Server-T” id=“N-8”>

<IP addresses=“10.1.123.4 9.9.99.4”/>
<OS name=“AIX” version=“6.1”/>
<Install name=“DB2” version=“9.1” id=“N-9”>

<Service name=“DB-01” type=“db2-instance” ports=“50000”
id=“N-10”>
<Object name=“DB-a” type=“database” id=“N-11”>

<Dependency
refurl=“fs://Server-T/db2/db1xxx001/db”
refid=“N-13”/>

</Object>
<Object name=“DB-b” type=“database” id=“N-12”>

<Dependency
refurl=“fs://Server-T/db2/db1xxx002/db”
refid=“N-13”/>

</Object>

</Service>

</Install>
<Install class=“FS” subclass=“NFS3” name=“nfs3” id=“N-13”>
...
</Install>

</Server>

FIGS. 3A and 3B show block diagrams of example source and target server and software components. In the figures, a server may include hardware components such as a physical machine with one or more processors, memory, storage devices and network connections. Software components are applications or software that can run (execute) on the processors, read and write (store) data from and to memory and storage devices, etc., for example, to perform their prescribed functions. The servers and software components in a source system in the configuration shown in FIG. 3A are to be migrated. In a migration design, one may design corresponding target servers S′ and T′, and because of the name changes, provide links that state that S′ is the target server of S and T′ is the target server of T′. FIG. 3B shows the actual migrated servers and software components in a target system. To make it more interesting, we assume as in FIGS. 3A and 3B that a migration design decision was made to split the file system holding the database data out of server T, i.e., not to migrate it to server T′, but to put it on the separate file server V′ that starts out as the migrated version of server V. The corresponding part of the target design may therefore be the following. The differences are shown below as follows: italicized bold face denotes changes, and where a line has been deleted from source to target, we annotate it as DELETED.

<Server name [symbol] id=“ [symbol] -0”>

[symbol]

<IP addresses=“ [symbol] 9.9.99.3”/>
<OS name=“AIX” version= [symbol] />
<Install name=“WebSphere application server” version=“5.3”
id=“ [symbol] -1”>

[symbol]

<Service name=“AppServer-A” type=“app_server”
ports=“9999 8888” id=“ [symbol] -2”>

[symbol]

<Object name=“Module1.war” type=“module” id=“ [symbol] -3”>

[symbol]

<Dependency refurl=“db2://Server- [symbol] :50000/DB-a”
refid=“ [symbol] -11”/>

</Object>
<Object name=“Module2.jar” type=“module” id=“ [symbol] -4”>

[symbol]

<Dependency refurl-“db2://Server- [symbol] :50000/DB-b”
refid=“ [symbol] -12”/>

</Object>

</Service>
<Service name=“AppServer-B” type=“app_server”
ports=“7777” id=“ [symbol] -5”>

[symbol]

<Object name=“Module3.war” type=“module” id=“ [symbol] -6”>

[symbol]

<Dependency refurl=“db2://Server- [symbol] :50050/DB-c”
refid=“ [symbol] -20”/>

</Object>

</Service>

</Install>
<Install name=“Apache HTTP Server” version=“2.0.52”
id=“ [symbol] -7”>

[symbol]

...
</Install>

</Server>
<Server name= [symbol] id=“ [symbol] -8”>

[symbol]

<IP addresses= [symbol] 9.9.99.4/>
<OS name=“AIX” version=“6.1”/>
<Install name=“DB2” version= [symbol] id=“ [symbol] -9”>

[symbol]

<Service name=“DB-01” type=“db2-instance”
ports=“50000” id=“ [symbol] -10”>

[symbol]

<Object name=“DB-a” type=“database” id=“ [symbol] -11”>

[symbol]

<Dependency refurl= [symbol] /db2/db1xxx001/db”
refid= [symbol] />

</Object>
<Object name=“DB-b” type=“database” id=“ [symbol] -12”>

[symbol]

<Dependency refurl= [symbol] /db2/db1xxx002/db”
refid=“ [symbol] ”/>

</Object>

</Service>

</Install>
<Install class=“FS” subclass=“NFS3” name=“nfs3”
id=“ [symbol] -11”> ← DELETED
...
</Install>

</Server>

Similarly, during the target design, target references may be added to the source descriptions; we only illustrate this for the first line of our example for simplicity:

<Server name=“Server-S” id=“N-0”>

[symbol]

<IP addresses=“10.1.123.3 9.9.99.3”/>
<OS name=“AIX” version=“5.3”/>
<Install name=“WebSphere application server” version=“5.3”
id=“N-1”>

[symbol]

<Service name=“AppServer-A” type=“app_server”
ports-“9999 8888” id=“N-2”>

[symbol]

In the above example, the source and target components have corresponding numbers (like T-0 corresponds to N-0), which is given only to illustrate an example. Any other references to source and target components may be utilized.

There are many other ways to describe source and target designs. For instance, instead of describing the entire target design at the same level of abstraction as the source design, one might only describe the changes. The target design might then start as follows in the above example:

<Server name= [symbol] id=“ [symbol] -0”>

[symbol]

<IP addresses replaced= [symbol] />
<OS version replaced= [symbol] />

In another variant, the dependencies are omitted in the target design description, and it is assumed that if two source software components have a dependency, such as Module 1 and DB a (shown in FIG. 3A), and if each has corresponding target components (as given by the references such as <Target=“T-x”/>), then those two target components should also have a dependency.

At 106, using the migration design 112, the discovered source and target applications, configurations and dependencies are compared. The comparison step may include applying the migration design 112 to the discovered source system, thus obtaining a desired target. The desired target is then compared with the discovered target system.

For instance, at 104 the method of the present disclosure may discover the example system shown in FIG. 3B. Continuing with the above example, assume that two errors were made in the migration: Database DB b was not migrated, and the address of Server U was not changed in Module 3. This is shown in FIG. 3B. The visual discovery result (which is stylized after the IBM Galapagos project) will show a dependency from Module 2 to a database called DB b on server T′ but no such database was discovered on server T′; hence it is shown as a so-called placeholder with dashed lines and without color (302). Furthermore, the visual discovery result will show a dependency from Module 3 to a database called DB c on a server called Server-U; no such database and no such server was discovered in the target (because the database DB c was correctly migrated to the server called Server-U′), so again there is a placeholder (304). Let us also illustrate how the first of these two sample migration errors might show up in the XML-style model of the discovered target; we only show the result for server T′:

<Server name=“Server-T’” id=“N-8”>

<IP addresses=“10.4.123.4 9.9.99.4”/>
<OS name=“AIX” version=“6.1”/>
<Install name=“DB2” version=“9.5” id=“N-9”>

<Service name=“DB-01” type=“db2-instance” ports=“50000”
id=“N-10”>

<Object name=“DB-a” type=“database” id=“N-11”>

<Dependency
refurl=“nfs://Server-V'/db2/db1xxx001/db”
refid=“N-30”/>

</Object>
<Object name=“DB-b” type=“database” discoverytstatus = “INFERRED” id=“p-1”
</Object>

</Service>

</Install>

</Server>

This is compared with the target design of server T′ (e.g., in one of the representations mentioned above) and one will notice that database DB-b was not discovered.

At 108, the results of the comparison may be stored, for example, in a computer file or a database. The comparison identifies target deviations. Target deviations refer to the differences between the desired target system (i.e., migration designs applied to the discovered source system or source components) and the actually migrated target system. For instance, un-designed changes (those changes not appearing in the migration design 112) but discovered in the actual migrated target may be logged, for instance, in a computer file or a database or the like. Changes specified in the migration design 112, but not appearing in the discovered changes may be also logged, similarly stored in a computer file or a database or the like. Un-designed changes may be identified, pulled (e.g., out of the large design) and shown or presented to a migration engineer, a system administrator, or another user. Similarly, changes in migration design 112 not in the discovered migrated system are shown or presented to a system administrator or another.

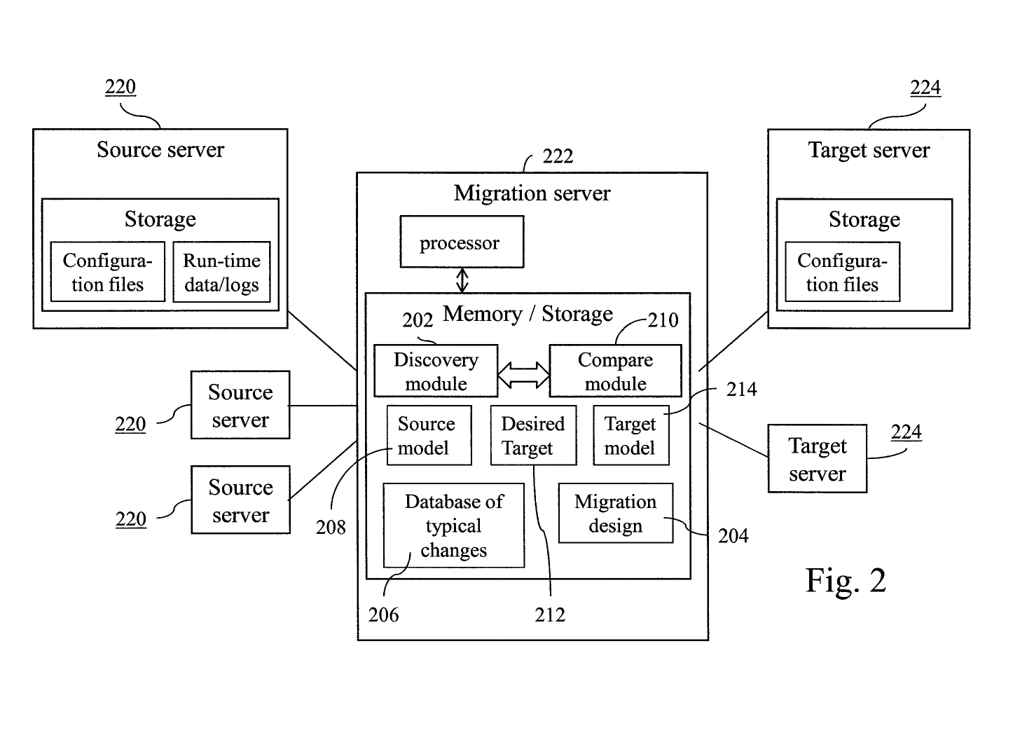

The migration design 112 (also, 204 in FIG. 2) in one embodiment may be recorded or stored, and represented as a data model with pointers cross-referencing the source software components and the corresponding target software components. As shown in the above examples, such data model may in XML format, a database, a spreadsheet, unified modeling language (UML), or other forms, or combinations thereof.

A database of typical changes 114 includes information associated with usual or common changes made during migration of software components or enterprise application from a source system to a target system. For instance, when a migration method is used where software is newly installed on the target systems, the install dates of the target software are different from the install dates of the corresponding source software. If a discovery method is used that outputs install dates for software install objects (not in the example above), then these changes have to be ignored. The database would contain that the attribute “installdate” of software components of type <Install> are to be ignored in the comparison. Similarly, certain “last used” or “last modified” dates may change, or certain sizes, e.g., of log files when those are newly initialized after a new installation. Such a database may be built up over time when using this testing method. It may be initialized by human experts classifying the objects and attributes that the discovery method discovers, or later when a change gets flagged and a human expert decides that this was not a migration error, but a false positive.

At 110, the un-designed changes identified may be further filtered. That is, the identified un-design changes are compared with the common changes in the database 114. The changes identified during comparison at 106 are then separated into those that are common and those that are unexpected (i.e., not found in the database 114).

The remaining, unexpected changes are treated as potential migration errors. This may mean bringing them to human attention. Design changes that did not take place properly are also brought to attention. In the example above, e.g., the fact that database DB b is missing is brought to human attention, and the human may decide that a manual migration of DB b from server T to server T′ needs to be performed. The human may also decide to inform the authors of an automated migration tool that may have been used that a database was missed (with more information about this database) and the authors may try to improve the migration tool for the future.

FIG. 2 is a system diagram illustrating components of the present disclosure in one embodiment. A system of the present disclosure may include a discovery module 202 that performs the discovery of configurations on a source system 220 to be migrated and a target system 224 which has the migrated source system 220. Source and target systems 220, 224 may include configuration files and data logs that provide information about the systems' configurations of its components. The discovery module 202 may be loaded into memory and run (executed) by a processor, for example, in a server system 222, and it may interact with or be partially or entirely loaded onto the source system 220 and the target system 224 in the process. A comparison module 210 compares the configurations of the source system 220 with those of the target system 224, taking into account the design changes specified in migration design 204. For example, the migration design 204 may be applied to the discovered model of the source system 220 to obtain a desired target configuration. The desired target configuration is then compared to the discovered target system 224. A database of typical changes 206 may be also utilized to identify and filter out those changes that may generally occur in migration so that the changes even if not in the migration design are not flagged as errors. For example, in one embodiment, a source system or software components of the source system being migrated may be modeled or represented as shown at 208, for example, in an XML format and stored as an XML file. Other representations or models are possible. The migration design 204, which may also be represented in an XML format (or another format) may be applied to the source model 208 to generate a desired target model 212. The desired target model also may be an XML file. The migrated target system (or migrated software components) is discovered from the target server 224 and may be modeled or represented as an XML file 214. The differences or deviations, if any, between the desired target and the discovered target may be identified by comparing the two models or in this example, XML files of the desired target 212 and the discovered target 214.

As described above, the method of the present disclosure may be used to immediately discover a root cause error. Referring to FIGS. 3A and 3B, this is shown via Module 3 on App server B, which after the migration still connects to DB c on Server U instead of DB c on Server U′. This may be detected by the method of the present disclosure in at least two ways: One way is by a comparison that for every dependency between two source components, there is also a dependency between the corresponding target components. In other words, here the method in one embodiment is distinguished from a pure configuration comparison by comparing the higher-level concept of “a dependency between two systems”, whereas pure configuration comparison would only compare the address parameter in Module 3 that is unchanged, and thus not notice a problem. The second way is provided by the method of the present disclosure in one embodiment because it can take a design into account. This design states that the address of server U changes, and thus the method of the present disclosure in one embodiment will notice that this address should also have changed where it is used in Module 3.

A migration testing method of the present disclosure may help with faster overall testing and remediation, may detect errors that other migration tests may not detect, and can deal with the fact that the source and target systems are not completely equal.

The results of the testing, for example, the determined deviations may be used to triggering additional migration steps that modify the configuration of the target software components and/or their dependencies to make the discovered target more like that of the desired migrated target. The results of the testing may be also used to identify one or more problems in a migration tool that might have caused the deviations and to improve the migration tool.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for discovery-based migration correctness testing, comprising:
discovering, using one or more processors, source software components, configurations of the source software components of a source system, and one or more dependencies between the source software components;
discovering, by one or more processors, target software components, configurations of the target software components of a target system, and one or more dependencies between the target software components;
comparing using a recorded migration design, the configuration of the source software components of a source system with the configuration of the target software components of a target system, and the one or more dependencies between the source software components with the one or more dependencies between the target software components; and
determining whether one or more deviations exist in the configuration of the target software and/or in said one or more dependencies between the target software components, from a desired migrated target as specified in the recorded migration design.

2. The method of claim 1, wherein the step of comparing using a recorded migration design includes applying the recorded migration design to the discovered configuration of the source software components of the source system to generate the desired migrated target, and comparing the desired migrated target with the discovered configuration of the target software components of the target system.

3. The method of claim 1, wherein the step of comparing further includes automatically checking that said one or more dependencies between the source software components also exist between the target software components.

4. The method of claim 1, further including storing results of the comparing step.

5. The method of claim 1, further including presenting the one or more deviations in response to identifying the one or more deviations in the step of determining.

6. The method of claim 1, further including in response to determining that said one or more deviations exist, filtering said one or more deviations by removing one or more commonly occurring changes from said one or more deviations.

7. The method of claim 1, wherein said one or more deviations include one or more changes in the recorded migration design that are not specified in the discovered configuration of the target software components, or one or more changes in the discovered configuration of the target software components that are not specified in the recorded migration design, or combinations thereof.

8. The method of claim 1, further including in response to identifying the one or more deviations in the step of determining, triggering additional migration steps to modify the configuration of the target software components to make it like that of the desired migrated target.

9. The method of claim 1, further including, in response to identifying the one or more deviations in the step of determining, using the determined one or more deviations to identify one or more problems in a migration tool and improve the migration tool.

10. The method of claim 1, wherein the recorded migration design is represented as a data model with pointers cross-referencing said one or more source software components and corresponding said one or more target software components.

11. The method of claim 10, wherein said data model is in XML format, a database, a spreadsheet, unified modeling language (UML), or combinations thereof.

12. A system for discovery-based migration correctness testing, comprising:
a processor;
a discovery module operable to discover source software components, configurations of the source software components of a source server, and one or more dependencies between the source software components, the discovery module further operable to discover target software components, configuration of the target software components of a target server, and one or more dependencies between the target software components; and
a comparison module operable to compare, using a migration design, the configuration of the source software components of a source server with the configuration of the target software components of a target server, and the one or more dependencies between the source software components with the one or more dependencies between the target software components,
the migration design including a plan of what elements of the source server should remain the same in the target server, and what elements should change in the target server,
the comparison module further operable to determine whether one or more deviations exist in the configuration of the target software and/or in said one or more dependencies between the target software components, from a desired migrated target as specified in the recorded migration design.

13. The system of claim 12, wherein the comparison module is operable to apply the migration design to the discovered configuration of the source software components of the source server to generate a desired target, and further compare the generated desired target with the discovered configuration of the target software components of the target server.

14. The system of claim 12, wherein the comparison module is further to automatically check that said one or more dependencies between the source software components also exist between the target software components.

15. The system of claim 12, further including a database storing common changes occurring in migration of one or more software components, and wherein the comparison module in response to determining that said one or more deviations exist, is further operable to filter said one or more deviations by removing one or more commonly occurring changes from said one or more deviations.

16. The system of claim 12, wherein said one or more deviations include one or more changes in the migration design that are not specified in the discovered configuration of the target software components, or one or more changes in the discovered configuration of the target software components that are not specified in the migration design, or combinations thereof.

17. The system of claim 12, wherein migration design is represented as a data model with pointers cross-referencing said one or more source software components and corresponding said one or more target software components.

18. The system of claim 17, wherein said data model is in XML format, a database, a spreadsheet, unified modeling language (UML), or combinations thereof.

19. A computer readable storage medium storing a program of instructions executable by a machine to perform a method of discovery-based migration correctness testing, comprising:
discovering source software components, configurations of the source software components of a source system, and one or more dependencies between the source software components;
discovering target software components, configurations of the target software components of a target system, and one or more dependencies between the target software components;
comparing using a migration design, the configurations of the source software components of a source system with the configurations of the target software components of a target system, and the one or more dependencies between the source software components with the one or more dependencies between the target software components; and
determining whether one or more deviations exist in the configurations of the target software and/or in said one or more dependencies between the target software components, from a desired migrated target as specified in the migration design.

20. The computer readable storage medium of claim 19, wherein the step of comparing using a migration design includes applying the migration design to the discovered configuration of the source software components of the source system to generate the desired migrated target, and comparing the desired migrated target with the discovered configuration of the target software components of the target system.

21. The computer readable storage medium of claim 19, wherein the step of comparing further includes automatically checking that said one or more dependencies between the source software components also exist between the target software components.

22. The computer readable storage medium of claim 19, further including in response to determining that said one or more deviations exist, filtering said one or more deviations by removing one or more commonly occurring changes from said one or more deviations.

23. The computer readable storage medium of claim 19, wherein said one or more deviations include one or more changes in the migration design that are not specified in the discovered configuration of the target software components, or one or more changes in the discovered configuration of the target software components that are not specified in the migration design, or combinations thereof.

24. The computer readable storage medium of claim 19, wherein the migration design is represented as a data model with pointers cross-referencing said one or more source software components and corresponding said one or more target software components.

25. A computer readable storage medium storing a program of instructions executable by a machine to perform a method of discovery-based migration correctness testing, comprising:
receiving data discovered associated with source software components to be migrated from a source server to a target server, the data associated with source software components including at least configurations of the source software components of the source server, and one or more dependencies between the source software components;
receiving data discovered associated with target software components corresponding to the source software components migrated to the target server, the data associated with target software components including at least configurations of the target software components of the target server, and one or more dependencies between the target software components;
comparing using a migration design, the configurations of the source software components with the configurations of the target software components, and the one or more dependencies between the source software components with the one or more dependencies between the target software components; and
determining whether one or more deviations exist in the configurations of the target software and/or in said one or more dependencies between the target software components, from a desired migrated target as specified in the migration design.
